(19) United States
(12) Patent Application Publication
(10) Pub. No.: US 2006/0093108 A1
(43) Pub. Date: May 4, 2006

(54) Electronic settlement system

(75) Inventor: Junichi Yamagishi, Higashi-Nihonbashi (JP)

Correspondence Address: JORDAN AND HAMBURG LLP, 122 EAST 42ND STREET, SUITE 4000, NEW YORK, NY, 10168, US

(73) Assignee: Nihon Unica Corporation, Chuo-ku (JP)

(21) Appl. No.: 11/255,222

(22) Filed: Oct. 19, 2005

(30) Foreign Application Priority Data
Oct. 20, 2004 (JP) 2004-305227

(51) Int. Cl. H04M 15/00

(52) U.S. Cl. 379/114.01

(57) ABSTRACT

An electronic settlement system is capable of preventing a place where a credit card has been used from being known to other people from a bill. In the electronic settlement system, a store terminal transmits billing information related to a user of a credit card to a management server. The management server transmits the billing information to a credit card company server. According to the billing information, the credit card company server sends a bill to the user. The bill mentions nothing about the place where the store terminal is installed and the user has used the credit card, and therefore, nobody can know the place from the bill.

### BACKGROUND OF THE INVENTION

1. Field of the Invention

The present invention relates to an electronic settlement system employing credit cards.

2. Description of Related Art

There is a settlement system employing credit cards. According to such a settlement system, a user uses a credit card at a store, and a credit card company sends a bill stating an amount of money used at the store, the name of the store where the user used the credit card, and the like. According to the bill, the user makes a payment to the credit card company. An example of such a settlement system is disclosed in Japanese Unexamined Patent Application Publication No. 07-171240.

The settlement system mentioned above sends to a user a bill that mentions an amount of money used with a credit card, the name of a store where the credit card was used, and the like. The user of the credit card may sometimes want to conceal, from other people, the place where the user used the credit card. Even in such a case, the place where the credit card was used will be known to other people from the bill because the bill sent to the user states the name of the place.

### SUMMARY OF THE INVENTION

An object of the present invention is to provide an electronic settlement system capable of preventing a place where a credit card has been used from being known to other people from a bill.

In order to accomplish the object, an aspect of the present invention provides an electronic settlement system having a communication terminal carried by a user of a credit card, a store terminal installed in a store where the credit card is usable, a management server which is provided with a customer database storing user data, and a credit card company server installed in a credit card company that manages the credit card. The communication terminal sends a credit card using request to the store terminal. Receiving the credit card using request, the store terminal transmits billing information to the management server. Receiving the billing information, the management server transfers the same to the credit card company server. Receiving the billing information, the credit card company server prepares a bill and sends the bill to the user.

In the electronic settlement system according to this aspect of the present invention, settlement between the store terminal and the credit card company server is carried out through the management server, and therefore, the bill sent to the user includes no mention about the place where the credit card has been used. Accordingly, nobody can know the place from the bill.

### BRIEF DESCRIPTION OF THE DRAWINGS

FIG. 1 is a general view showing an electronic settlement system according to an embodiment of the present invention;

FIG. 2 is a flowchart showing a registration process according to an embodiment of the present invention; and

FIG. 3 is a flowchart showing a credit card handling process according to an embodiment of the present invention.

### DETAILED DESCRIPTION OF EMBODIMENTS

An electronic settlement system according to an embodiment of the present invention will be explained.

[Configuration of Electronic Settlement System]

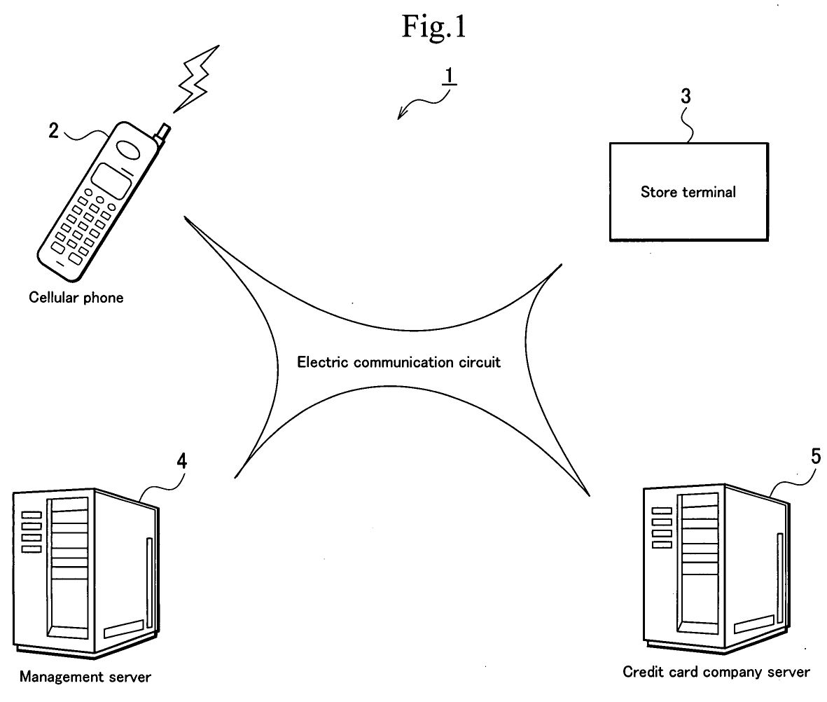

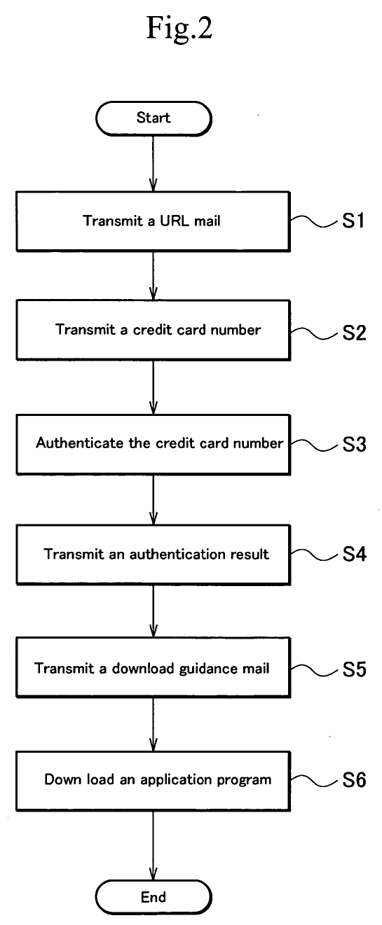

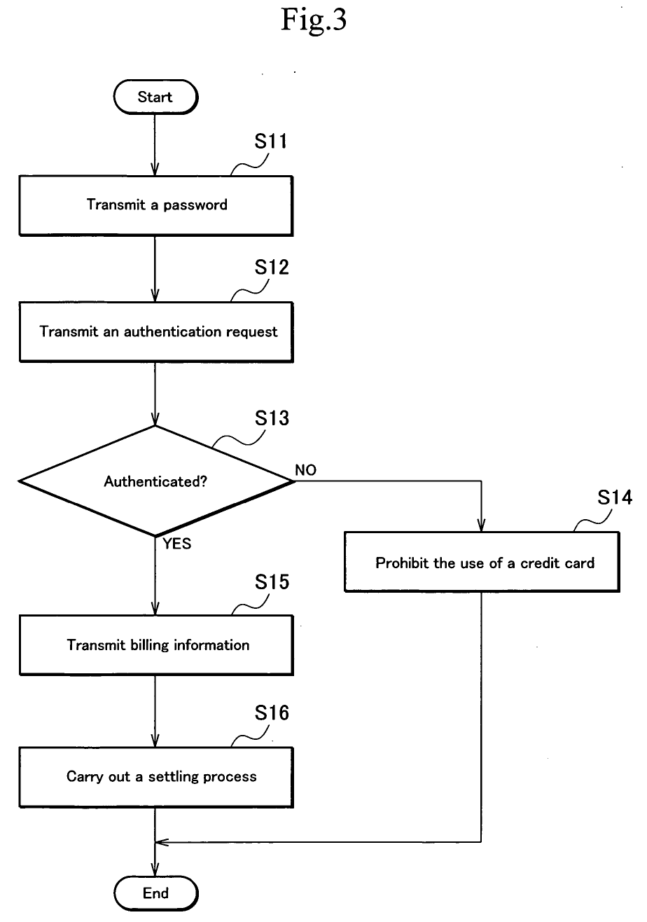

FIG. 1 shows the electronic settlement system 1 according to the embodiment of the present invention. The system 1 includes a cellular phone 2 carried by a user who possesses a credit card, a store terminal 3 installed in a store where the credit card is usable, a management server 4 installed on a management side that manages the system 1, and a credit card company server 5 arranged in a credit card company. These components of the system 1 can communicate with one another through electric communication circuits. The management server 4 has a customer database (DB) to store customer data about users who use the system 1. The system 1 with this configuration executes a registration process and a credit card handling process to be explained later. With these processes, the system 1 prevents a place of use of the credit card from being known to other people. With reference to the flowcharts of FIGS. 2 and 3, the registration process and credit card handling process will be explained.

[Registration Process]

With reference to the flowchart of FIG. 2, the registration process executed by the electronic settlement system 1 will be explained. The registration process registers data about a user who uses the system 1.

Before starting the registration process, the user fills a registration form for using the electronic settlement system 1 and transmits by facsimile the filled registration form to the store in which the store terminal 3 is installed. A manager of the store transfers by facsimile the filled registration form to the management side where the management server 4 is installed. The management side stores data written in the registration form as customer data into the customer database (not shown). Items to be filled in the registration form include at least identification data (ID) and a password both specific to the user. Thereafter, the registration process of FIG. 2 starts at step S1.

In step S1, the management server 4 sends an electronic mail stating a URL (universal resource locator) for entering a credit card number to the cellular phone 2 of the user. This completes step S1, and the registration process proceeds to step S2.

In step S2, the user manipulates the cellular phone 2 to access the URL written in the electronic mail and enter a credit card number. The cellular phone 2 encodes the credit card number and transmits it to the management server 4. At this time, it is preferable to also transmit an expiration data of the credit card from the cellular phone 2. This completes step S2, and the registration process proceeds to step S3.

In step S3, the management server 4 receives the transmitted credit card number, stores the same in the customer database, and transmits an authentication request for the credit card number to the credit card company server 5. This completes step S3, and the registration process proceeds to step S4.

In step S4, the credit card company server 5 sends a result of authentication of the credit card number to the management server 4. If the credit card number has been authenticated, the result includes an amount of money the user can spend. According to an embodiment of the present invention, the amount of money of the credit card the user can spend is updatable by the user. This completes step S4, and the registration process proceeds to step S5.

In step S5, the management server 4 stores, if the credit card number has been authenticated, the spendable amount of money in the customer database. Thereafter, the management server 4 sends a download guidance mail to the cellular phone 2 of the user. The download guidance mail asks the user to download an application program needed when using the electronic settlement system 1. This completes step S5, and the registration process proceeds to step S6.

In step S6, the user receives, with the cellular phone 2, the download guidance mail, and according to the mail, downloads the application program from the management server 4 into the cellular phone 2. This completes step S6, and the registration process ends.

[Credit Card Handling Process]

With reference to the flowchart of FIG. 3, the credit card handling process executed by the electronic settlement system 1 will be explained. This process is carried out when the user uses the credit card at the store.

The flowchart of FIG. 3 starts at step S11 when the user goes to the store where the user can use the credit card and activates the application program to pay a bill with the credit card.

In step S11, the cellular phone 2 prompts the user to enter the registered password, and when the user enters the password, transmits the entered password to the store terminal 3. This completes step S11, and the credit card handling process proceeds to step S12.

In step S12, the store terminal 3 transmits the entered password and an amount of the bill to the management server 4 and asks the management server to authenticate the user. This completes step S12, and the credit card handling process proceeds to step S13.

In step S13, the management server 4 refers to the customer database and determines whether or not the entered password is right and whether or not the amount of the bill is within the usable amount of money of the user, thereby authenticating the user. If the user is not authenticated, the management server 4 informs the store terminal 3 that the user has not been authenticated. Then, the store terminal 3 prohibits, in step S14, the user from using the credit card. If the user is authenticated, the credit card handling process proceeds to step S15.

In step S15, the management server 4 informs the store terminal 3 that the user has been authenticated, and the store terminal 3 charges the bill to the credit card number. Thereafter, the user can receive a corresponding service from the store. The store terminal 3 transmits billing information to the management server 4. This completes step S15, and the credit card handling process proceeds to step S16.

In step S16, the management server 4 stores the billing information in the customer database and transmits the same to the credit card company server 5. According to the billing information, the credit card company server 5 sends a bill to the user periodically. According to the bill, the user pays. The credit card company pays money to the management side according to the money paid by the user, and the management side pays money to the store according to the money paid by the credit card company. This completes step S16, and the credit card handling process ends.

As mentioned above, according to the electronic settlement system 1 of the embodiment of the present invention, the store terminal 3 transmits, to the management server 4, billing information for an amount of money spent in the store by the user with the credit card. The management server 4 transmits the billing information to the credit card company server 5. According to the billing information, the credit card company sends a bill to the user. Namely, according to the electronic settlement system 1 of the embodiment conducts settlement between the store terminal 3 and the credit card company server 5 through the management server 4. Accordingly, the bill issued from the credit card company to the user states the name of a company who controls the management server 4 instead of the place (store) where the credit card has been used. Namely, the name of the store having the store terminal 3 with which the credit card has been used is never written in the bill, and therefore, is never known to other people.

Although the present invention has been explained with reference to the embodiments, it must be understood that the embodiments, descriptions, and drawings disclosed herein are not intended to limit the present invention.

What is claimed is:

1. An electronic settlement system comprising:
a communication terminal carried by a user of a credit card;
a store terminal installed in a store where the credit card is usable;
a management server which is provided with a customer database storing user data; and
a credit card company server installed in a credit card company that manages the credit card, wherein:
the communication terminal sends a credit card using request to the store terminal;
receiving the credit card using request, the store terminal transmits billing information to the management server;
receiving the billing information, the management server transfers the same to the credit card company server; and
receiving the billing information, the credit card company server prepares a bill and sends the bill to the user.

2. The system of claim 1, wherein:
receiving the billing information from the store terminal, the management server authenticates the user by referring to the customer database, and only when the user is successfully authenticated, transfers the billing information to the credit card company server.
